(19) United States
(12) Patent Application Publication
(10) Pub. No.: US 2007/0165505 A1
(43) Pub. Date: Jul. 19, 2007

(54) Information playback apparatus and recording medium

(76) Inventor: Daisuke Takeuchi, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/640,928

(22) Filed: Dec. 19, 2006

(30) Foreign Application Priority Data
Dec. 26, 2005 (JP) 2005-373314

(51) Int. Cl. G11B 15/04

(52) U.S. Cl. 369/53.24

(57) ABSTRACT

According to one embodiment, an information playback apparatus which plays back content to be played back recorded on a recording medium, and displays the content on a display unit, includes a plurality of specific function keys which accept an execution request for each predetermined function in the information playback apparatus, and at least one versatile function key which accepts an execution request for a settable function in the information playback apparatus. Furthermore, the information playback apparatus includes an MPU unit which associates a function to be accepted by each versatile function key with a corresponding versatile function key, based on function definition information which is recorded on the recording medium and defines a function to be accepted by each versatile function key.

### CROSS-REFERENCE TO RELATED APPLICATIONS

This application is based upon and claims the benefit of priority from Japanese Patent Application No. 2005-373314, filed Dec. 26, 2005, the entire contents of which are incorporated herein by reference.

### BACKGROUND

1. Field

One embodiment of the invention relates to a recording medium such as an optical disk (e.g., a DVD) and a hard disk, and an information playback apparatus which plays back information to be played back on the recording medium.

2. Description of the Related Art

Recently, an information playback apparatus which plays back information (also referred to as “content” hereinafter) recorded on a recording medium such as an optical disk (e.g., a DVD) and a hard disk has become popular.

Conventionally, in this type of information playback apparatus, a main body or remote controller has various operation keys (also referred to as “operation buttons” hereinafter) for accepting execution requests such as content playback/recording, timed recording, and control of volume, channel, image quality, power supply, and the like. These operation keys accept only predetermined execution requests, and these execution requests cannot be changed. That is, the operations keys of the conventional information playback apparatus are specific function keys for implementing only specific functions.

On the other hand, a data broadcast receiving apparatus which receives data broadcasts includes not only such specific function key but also a so-called versatile function key capable of changing, as needed, a function for an execution request to be accepted.

It is disclosed by, for example, Jpn. Pat. Appln. KOKAI Publication No. 2004-194126 to provide a data broadcast receiving apparatus which analyzes a function for an effective operation in accordance with user interface information obtained from a data broadcast. Based on the analysis result, the function for the execution request to be accepted by the versatile function key is set, and the data broadcast receiving apparatus is informed of the content of the set function.

As described above, the data broadcast receiving apparatus can assign a function to a versatile function key for each program and received picture, even when data broadcast programs have inconsistent user interfaces.

The information playback apparatus also requires such a versatile function key. Especially, when a large-capacity optical disk such as an HD-DVD becomes popular, new content not available before may be supplied. For example, movie content with the characteristics of a simulation game may be supplied. As for this movie content, when playing back a video until a branch point is reached, a viewer can select one of the scenarios to be played back. Additionally, content for playing back a video depending on a quiz answer or game progress may be supplied.

In playing back such content, it is easily seen that an environment for comfortably operating the content cannot be provided only by using the specific function key. Because it is difficult to predict content to be supplied in future, all specific function keys cannot be predicted and efficiently arranged while considering the operability for each type of content to be supplied in future. This increases the number of keys, thus complicating and enlarging the structure of an apparatus main body and remote controller, decreasing design freedom, and degrading user operability.

Furthermore, in order to provide a comfortable operating environment for a user, it is desirable that the information playback apparatus includes a versatile function key, and a suitable function can be automatically assigned to the versatile function key.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a functional block diagram showing the arrangement of an information playback apparatus according to an embodiment of the invention;

FIG. 2 is a layout view of a graphic unit GU in a video object;

FIG. 3 is an outline view showing an example of a remote controller with versatile function keys in the information playback apparatus according to the embodiment of the invention;

FIG. 4 is a functional block diagram showing the arrangement of an MPU unit;

FIG. 5 is a table showing a data arrangement in association information; and

FIG. 6 is a flowchart showing an example of a process associated with the versatile function key of the information playback apparatus according to the embodiment.

### DETAILED DESCRIPTION

Various embodiments according to the invention will be described hereinafter with reference to the accompanying drawings. In general, according to one embodiment of the invention, an information playback apparatus which plays back information to be played back recorded on a recording medium, and displays the playback information on a display unit, comprises a plurality of specific function keys, at least one versatile function keys, and a function association unit. The plurality of specific functions keys accept execution requests for respective predetermined functions in the information playback apparatus. The at least one versatile function keys accept an execution request for a settable function in the information playback apparatus. The function association unit associates a function to be accepted by each versatile function key with a corresponding versatile function keys, based on function definition information which is recorded on the recording medium and defines a function to be accepted by each versatile function key.

According to another embodiment of the invention, a recording medium recording playback information to be played back by an information playback apparatus which includes a specific function key for accepting an execution request for each predetermined function, and at least one versatile function keys for accepting an execution request for a settable function records function definition information which defines a function to be accepted by each versatile function key.

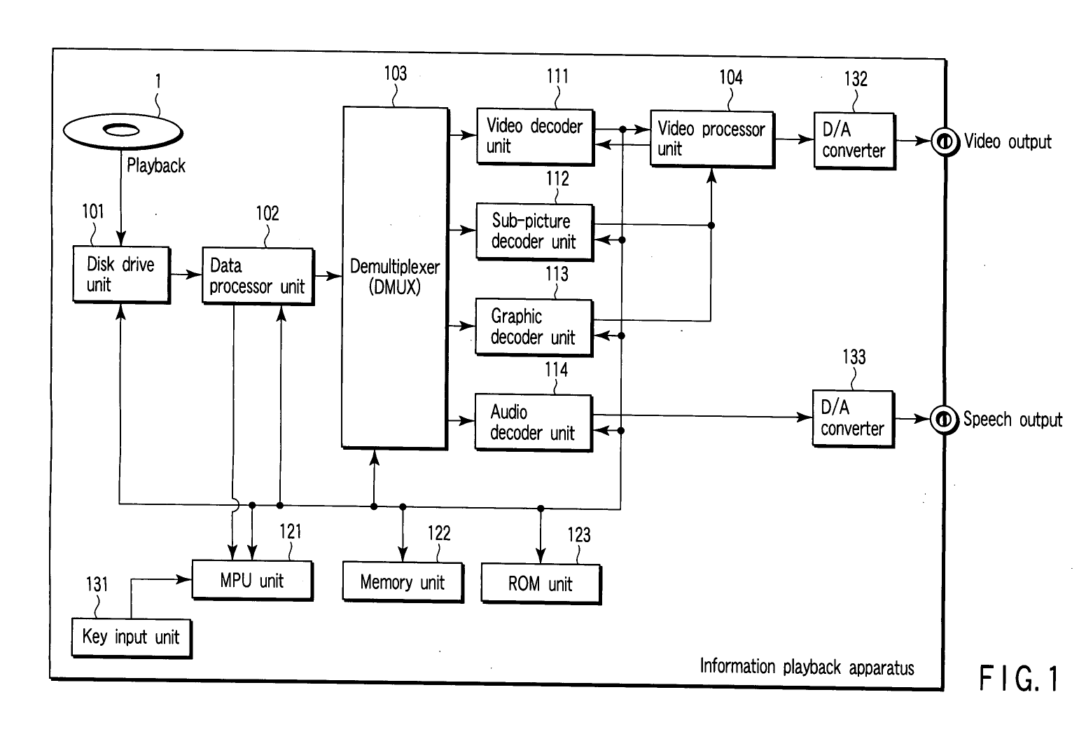

According to an embodiment, FIG. 1 shows a functional block diagram showing the arrangement of the information playback apparatus.

That is, the information playback apparatus according to this embodiment plays back content recorded on a recording medium 1 such as an optical disk (e.g., HD-DVD) and a hard disk, and displays the content on a display device. A disk drive unit 101 plays back HD-DVD video content from the recording medium 1, and then transfers the content to a data processor unit 102.

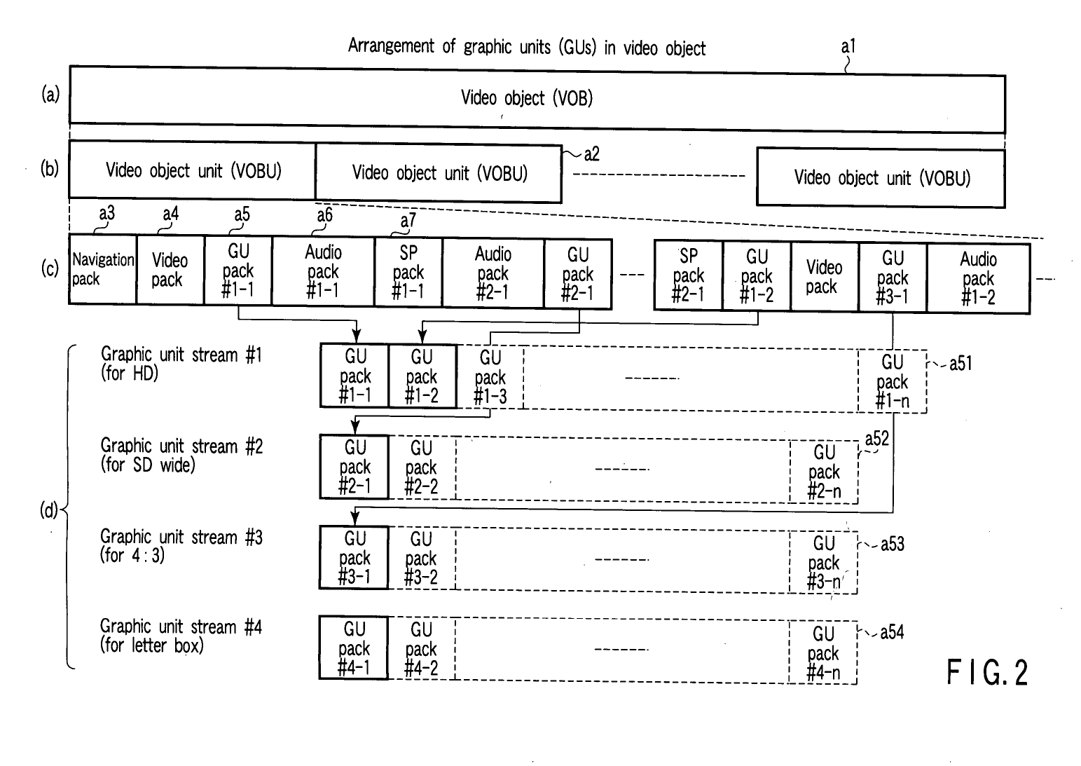

As shown in FIG. 2, a video object (VOB) a1 serving as video data in the HD-DVD video content has a group of video object units (VOBUs) a2 serving as basic units. Each VOBU a2 has a navigation pack a3 at its beginning. Video data, audio data, and sub-picture data are distributed and respectively arranged in a video pack a4, audio pack a6, and sub-picture (SP) pack a7, and multiplexed. According to the embodiment, each VOBU a2 also has graphic unit data distributed and recorded in a graphic unit (GU) pack a5. A demultiplexer 103 divides, into packets, the VOB a1 in which various data are multiplexed. The demultiplexer 103 transfers the video data recorded in the video pack a4, sub-picture data recorded in the sub-picture pack a7, graphic data recorded in the graphic unit pack a5, and audio data recorded in the audio pack a6 to a video decoder unit 111, sub-picture decoder unit 112, graphic decoder unit 113, and audio decoder unit 114, respectively. The decoder units 111 to 114 decode the transferred various data. Decoded data are synchronized by a video processor unit 104, converted into analog signals by digital-to-analog converters 132 and 133, and then output. An MPU unit 121 collectively manages the series of processes, and temporarily stores, in a memory unit 122, data to be temporarily stored in these processes. A ROM unit 123 stores a processing program and preset fixed information to be processed by the MPU unit 121.

Referring to FIG. 1, a key input unit 131 in the information playback apparatus main body inputs, with a key, information to be input from a user to the information playback apparatus. The key input unit 131 need not always be included in the information playback apparatus main body. The key input unit 131 may be included in the remote controller for remotely controlling the information playback apparatus.

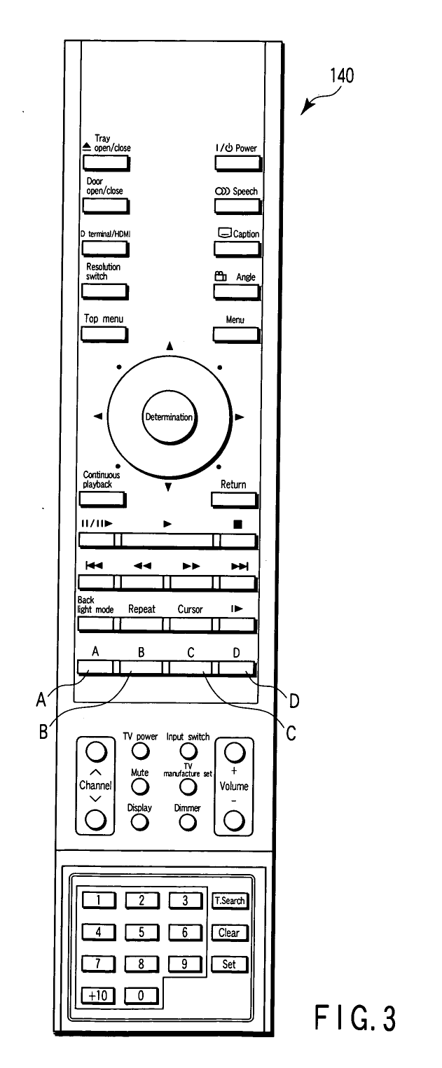

FIG. 3 is an outline view showing an example of a remote controller 140 having versatile function keys A, B, C, and D of the information playback apparatus according to the embodiment of the present invention. The remote controller 140 shown in FIG. 3 has a plurality of specific function keys (e.g., a playback button, stop button, fast forward button, rewind button, ten keys, determination button, channel button, and volume button) each of which accepts an execution request for a predetermined function in the information playback apparatus, and four versatile function keys A, B, C, and D each of which accepts an execution request for a settable function in the information playback apparatus. Note that such versatile function keys may be arranged in the key input unit 131 in place of the remote controller 140, or arranged in both the key input unit 131 and remote controller 140. The number of versatile function keys is not limited to four as a matter of course. More or less versatile function keys may be arranged.

Note that the remote controller 140 shown in FIG. 3 also has other keys and buttons for controlling the basic operations of the information playback apparatus. Since these keys and buttons are well known, detailed description of their functions will be omitted.

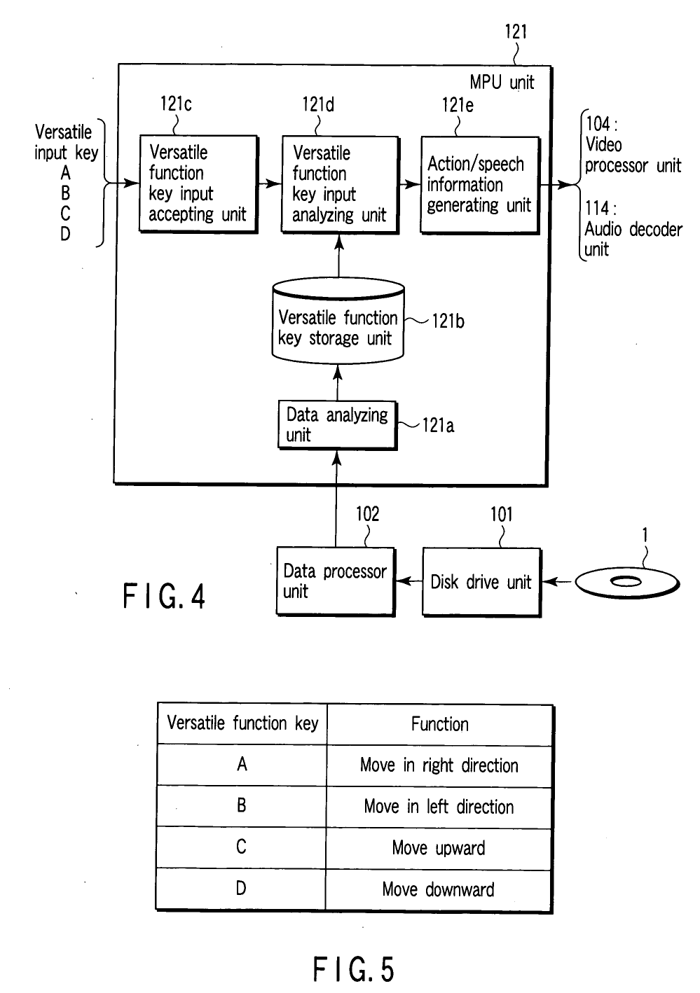

FIG. 4 is a functional block diagram showing the arrangement of the MPU unit 121.

The MPU unit 121 includes a data analyzing unit 121a, versatile function key storage unit 121b, versatile function key input accepting unit 121c, versatile function key input analyzing unit 121d, and video/audio information generating unit 121e as elements which characterize this embodiment.

In this embodiment of the present invention, the recording medium 1 records content and the function definition information which defines each function to be accepted by each versatile function key.

Upon insertion of the recording medium 1, the above-described disk drive unit 101 outputs the function definition information from the recording medium 1 to the MPU unit 121 via the data processor unit 102.

With such processing, the data analyzing unit 121a in the MPU unit 121 acquires the function definition information output from the disk drive unit 101 via the data processor unit 102. The data analyzing unit 121a associates a function to be accepted by each versatile function key with a corresponding versatile function key based on this function definition information. The versatile function key storage unit 121b stores the association information containing the set of the versatile function key and function associated with each other. FIG. 5 is a table showing a data arrangement in the association information.

Assume that the recording medium 1 records a science-fiction adventure movie as information to be played back. FIG. 5 shows functions corresponding to content in which the picture of a fighter aircraft to be operated by a viewer can be displayed in the air battle scene of this movie. In this case, the versatile function keys A, B, C, and D are associated with each other as functions of moving the picture of the fighter aircraft in the right direction, in the left direction, upward, and downward. As a matter of course, the functions to be accepted by the versatile function keys are not limited to these, and various functions may be accepted.

When the user presses one of the versatile function keys, the versatile function key input accepting unit 121c receives a depression signal output from the versatile function key. This depression signal contains an identification information for identifying the pressed versatile function key. The versatile function key input accepting unit 121c outputs the accepted depression signal to the versatile function key input analyzing unit 121d.

The versatile function key input analyzing unit 121d determines the pressed versatile function key based on the identification information contained in the depression signal output from the versatile function key input accepting unit 121c. The versatile function key input analyzing unit 121d also recognizes the function associated with the determined versatile function key, based on the association information (e.g., shown in FIG. 5) stored in the versatile function key storage unit 121b. The versatile function key input analyzing unit 121d then outputs the recognition result to the video/audio information generating unit 121e. For example, when the identification information contained in the depression signal output from the versatile function key input accepting unit 121c indicates the versatile function key A, the versatile function key input analyzing unit 121d determines that the versatile function key A is pressed. Based on this association information, the versatile function key input analyzing unit 121d recognizes the function associated with the versatile function key A. For example, based on the association information shown in FIG. 5, the versatile function key input analyzing unit 121d recognizes that the function associated with the versatile function key A is the function of moving the picture of the fighter aircraft in the right direction.

The video/audio information generating unit 121e generates video information and/or audio information corresponding to the recognition result output from the versatile function key input analyzing unit 121d. The video/audio information generating unit 121e outputs the video information and the audio information to the video processor unit 104 and the audio decoder unit 114, respectively.

Upon receiving the video information from the video/audio information generating unit 121e, the video processor unit 104 outputs a video signal via the digital-to-analog converter 132 depending on the received video information. Upon receiving the audio information from the video/audio information generating unit 121e, the audio decoder unit 114 outputs an audio signal via the digital-to-analog converter 133 depending on the received audio information.

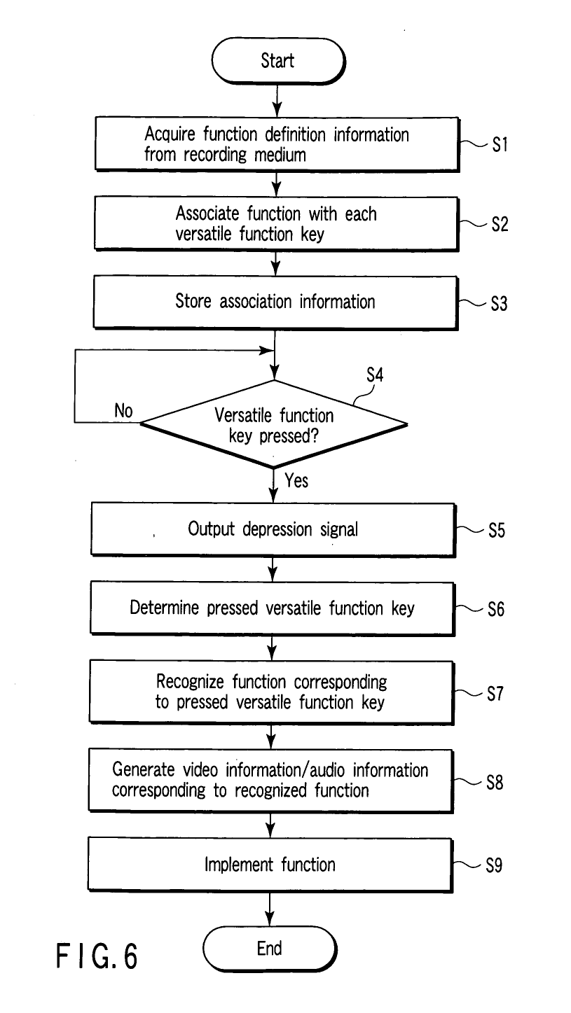

An example of the process associated with the versatile function key of the information playback apparatus having the above-described arrangement according to this embodiment will be described with reference the flowchart of FIG. 6.

When the user inserts the recording medium 1 into the disk drive unit 101, the disk drive unit 101 acquires function definition information from the recording medium 1 to output the acquired function definition information to the MPU unit 121 via the data processor unit 102 (step S1).

With such processing, the data analyzing unit 121a in the MPU unit 121 acquires the function definition information output from the disk drive unit 101 via the data processor unit 102. The data analyzing unit 121a associates a function to be accepted by each versatile function key with a corresponding versatile function key based on this function definition information (step S2).

The data analyzing unit 121a writes, in the versatile function key storage unit 121b, the association information containing the set of the versatile function key and function associated with each other (step S3). FIG. 5 is a table showing a data arrangement in the association information.

When the user presses one of the versatile function keys (step S4: YES), the versatile function key input accepting unit 121c receives a depression signal output from the versatile function key (step S5). This depression signal contains an identification information for identifying the pressed versatile function key. The versatile function key input accepting unit 121c outputs the depression signal to the versatile function key input analyzing unit 121d.

The versatile function key input analyzing unit 121d determines the pressed versatile function key based on the identification information contained in the depression signal output from the versatile function key input accepting unit 121c (step S6). The versatile function key input analyzing unit 121d also recognizes the function associated with the determined versatile function key, based on the association information (e.g., shown in FIG. 5) stored in the versatile function key storage unit 121b (step S7). The versatile function key input analyzing unit 121d then outputs the recognition result to the video/audio information generating unit 121e.

For example, in step S6, when the identification information contained in the depression signal output from the versatile function key input accepting unit 121c indicates the versatile function key A, the versatile function key input analyzing unit 121d determines that the versatile function key A is pressed. Based on this association information, the versatile function key input analyzing unit 121d recognizes the function associated with the versatile function key A.

The video/audio information generating unit 121e generates video information and/or audio information corresponding to the recognized function. The video/audio information generating unit 121e outputs the video information and the audio information to the video processor unit 104 and the audio decoder unit 114, respectively (step S8).

Upon receiving the video information from the video/audio information generating unit 121e, the video processor unit 104 outputs a video signal via the digital-to-analog converter 132 depending on the received video information. Upon receiving the audio information form the video/audio information generating unit 121e, the audio decoder unit 114 outputs an audio signal via the digital-to-analog converter 133 depending on the received audio information. With this processing, the function associated with the pressed versatile function key is implemented (step S9).

As described above, the recording medium according to this embodiment of the present invention can record content to be played back by the information playback apparatus, and function definition information which defines a function to be accepted by the versatile function key of the information playback apparatus. The function to be accepted by each versatile function key arranged in the information playback apparatus is assigned to the corresponding versatile function key based on the recorded function definition information.

Additionally, the information playback apparatus according to this embodiment of the present invention has a versatile function key for accepting an execution request for a settable function, and can set the function of accepting the execution request to the versatile function key based on the function definition information recorded on the recording medium. Upon depression of a versatile function key, a function associated with the pressed versatile function key can be implemented. With these processes, a content provider can provide content to be implemented more freely (more specifically, in a game program, more amusing content can be provided), and also provide a more comfortable operating environment for a user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information playback apparatus which plays back information to be played back recorded on a recording medium, and displays the playback information on a display unit, comprising:
a plurality of specific function keys configured to accept execution requests for respective predetermined functions in the information playback apparatus;
at least one versatile function keys configured to accept an execution request for a settable function in the information playback apparatus; and
a function association unit configured to associate a function to be accepted by each versatile function key with a corresponding versatile function key, based on function definition information which is recorded on the recording medium and defines a function to be accepted by each versatile function key.

2. An apparatus according to claim 1, further comprising
a storage device configured to store association information containing a set of the versatile function key and the function which are associated by the function association unit, and
a process execution unit configured to, upon depression of one of the versatile function keys, recognize the function associated with the pressed versatile function key based on the association information stored in the storage device, and execute a process for the recognized function.

3. A recording medium recording:
playback information to be played back by an information playback apparatus which includes a specific function key for accepting an execution request for each predetermined function, and at least one versatile function key for accepting an execution request for a settable function; and
function definition information which defines a function to be accepted by each versatile function key.
